(19) United States
(12) Patent Application Publication
(10) Pub. No.: US 2004/0219924 A1
(43) Pub. Date: Nov. 4, 2004

(54) Systems and methods for optimizing a wireless communication network

(75) Inventor: Michael Patrick Flynn, Cota de Caza, CA (US)

Correspondence Address: ORRICK, HERRINGTON & SUTCLIFFE, LLP, 4 PARK PLAZA, SUITE 1600, IRVINE, CA, 92614-2558, US

(73) Assignee: MPF Technologies, Inc.

(21) Appl. No.: 10/426,713

(22) Filed: Apr. 29, 2003

(51) Int. Cl. H04Q 7/20

(52) U.S. Cl. 455/446; 455/562.1; 455/575.7

(57) ABSTRACT

Systems and methods are provided that allow the optimization of wireless coverage by a wireless network in a wireless coverage impeded region. More particularly, an antenna system is integratable with one or more infrastructure elements throughout the impeded region. The infrastructure element can be pre-existing throughout the region and serve as a basis for the optimization of a wireless system throughout the region. The infrastructure element can also be added to the region when the existence of the element is known or accepted through the region. The antenna system can include an antenna communicatively coupled with a base communication unit and linked with a wireless network through a base station.

### FIELD OF THE INVENTION

The invention relates generally to a wireless communication system and more particularly, to the optimization of antenna coverage within a wireless communication system.

### BACKGROUND INFORMATION

A typical wireless communication system relies on an antenna placed in an elevated location to communicate with various wireless devices dispersed throughout a given region. Antennas used for wireless transmissions are typically located on vertical towers, water tanks or other elevated structures. The most common type of vertical tower is referred to as a base station and includes the communication hardware necessary to provide a link to the wireless service provider. This link is typically a landline such as a T1 or T3 communication line. Another type of vertical tower is referred to as a repeater. Repeaters are used to relay wireless signals between mobile devices and base stations and can be used either alone or in conjunction with multiple repeaters. Repeaters typically receive and retransmit wireless communications at a higher signal strength or in a specified direction in order to increase the range of a base station or other vertical antenna structure.

A typical height for a vertical antenna structure is 50-200 feet. The antennas can assume one of many various configurations. For instance, in some rural areas the structure can use an omni-directional antenna that resembles a pole, 10 to 15 feet in length. Generally, in urban areas, the structure may implant directional, or sector antennas that are typically rectangular panels, approximately 1 by 4 feet in dimension and arranged in groups of three or more. Despite the height and configuration of the antennas, wireless coverage can still be significantly impeded in certain regions. For instance, wireless signals do not propagate well in urban areas where there are numerous multi-story buildings or high rises. This is also true in regions where there are broad elevational changes in the geography, such as that which occurs with the presence of canyons, valleys, mountains, hills, plateaus, cliffs and the like. In addition, some regions may impede wireless coverage by regulating the height, appearance or distribution of the vertical antenna structures. Several examples of these regions include green spaces such as parks, historical districts and residential areas.

### SUMMARY

The present invention is directed to systems and methods that allow optimization of wireless coverage throughout a wireless impeded region by integration of an antenna system with an infrastructure element. In one embodiment, the infrastructure element is a pre-existing element of the impeded region, while in another embodiment, the element is added to the region and is known or allowed within the region. The antenna system can include an antenna communicatively coupled with a base communication unit and can be configured to communicate with one or more wireless devices. The base communication unit can be configured to relay communications between the antenna and a wireless network.

In one embodiment, the infrastructure element is a housing configured to resemble an infrastructure element, such as a typical window mounted air-conditioning unit. An antenna system is integrated with the housing and implemented in a historic or urban area where the presence of the infrastructure element is not restricted while the presence of a vertical antenna structure is. In another embodiment, the infrastructure element is a raised road reflector and the antenna is integrated within the reflector and embedded in a road where wireless coverage is impeded. The infrastructure element can assume numerous embodiments such as a road, a guard rail, a telephone pole, a lamp post and the like. In another embodiment, the antenna is a radio frequency radiating cable integrated with the infrastructure element and distributed through the impeded region. For instance, the radiating cable can be integrated within the road and distributed through the impeded region, or the radiating cable can be integrated with the guard rail and run alongside a road through the impeded region. Many embodiments of the infrastructure element and antenna, as well as many embodiments of methods of integrating the antenna with the infrastructure element are contemplated by the invention and the preceding embodiments serve as several examples of the many possible embodiments.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. It is also intended that features and aspects of each embodiment can be combined and integrated with those of other embodiments.

### BRIEF DESCRIPTION OF THE FIGURES

The details of the invention, including fabrication, structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 depicts a schematic view of one. exemplary embodiment of a wireless system.

FIG. 2A depicts a schematic view of another exemplary embodiment of a wireless system.

FIG. 2B depicts a schematic view of another exemplary embodiment of a wireless system.

FIG. 3A depicts a perspective view of another exemplary embodiment of a wireless system.

FIG. 3B depicts a side view of another exemplary embodiment of a wireless system.

FIG. 3C depicts a top view of another,exemplary embodiment of a wireless system.

FIG. 3D depicts a front view of another exemplary embodiment of a wireless system.

FIG. 4 depicts a perspective view of another exemplary embodiment of a wireless system.

FIG. 5 depicts a schematic view of another embodiment of a wireless system.

FIG. 6 depicts a schematic view of another embodiment of a wireless system.

FIG. 7 depicts a schematic view of another embodiment of a wireless system.

FIG. 8 depicts a schematic view of another embodiment of a wireless system.

FIG. 9 depicts a schematic view of another embodiment of a wireless system.

FIG. 10 depicts a schematic view of another embodiment of a wireless system.

### DETAILED DESCRIPTION

The systems and methods described herein provide for the optimization of a wireless communication system. More specifically, the systems and methods provide for the integration of an antenna with an infrastructure element in a region where wireless coverage is impeded by geographical, political or social factors. By using the infrastructural element, the system is able to provide wireless coverage in locales throughout the impeded region where demand is significant, while maintaining a minimal cost. The antenna is preferably configured to communicate with a wireless device, such as a mobile phone, and a base station linked with a wireless network.

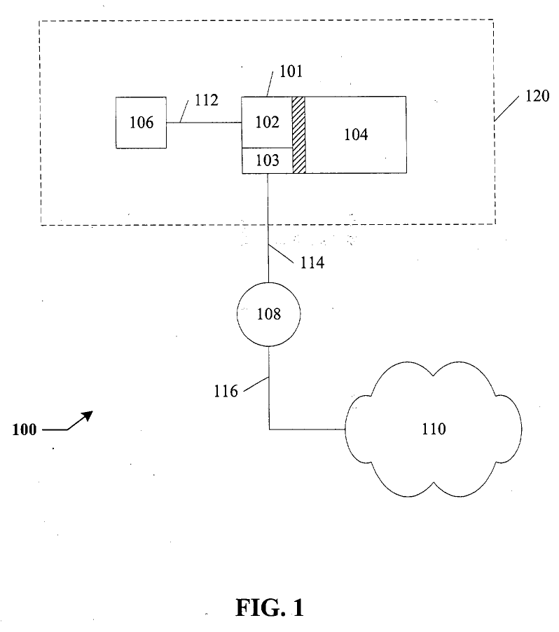

FIG. 1 depicts an optimized wireless communication system 100, which is a preferred embodiment of the systems and methods described herein. Included within the optimized wireless system 100 is an antenna system 101, an infrastructure element 104, a mobile device 106, a base station 108 and a wireless network 110. The antenna system 101 is integrated with the infrastructure element 104 and includes an antenna 102 and a base communication unit 103. The antenna 102 is configured to communicate with the mobile device 106 using a wireless communication path 112. The base communication unit 103 is configured to communicate with the base station 108 and links the antenna 102 with the base station 108 using a communication path 114, which can be either a wireless or wireline communication path. The base station 108, in turn, is communicatively coupled with the wireless network 110 over a communication path 116 and provides the communication link between the antenna system 102 and the wireless network 110. The communication path 116 can also be a wireless or wireline path. The wireless network 110 and the base station 108 can be located anywhere in or around a region 120.

The implementation of the wireless system 100 and the various elements within the wireless system 100 will vary with the type of wireless communication standard or technique employed. Therefore, the antenna 102, the wireless device 106, the base station 108, the wireless network 110 and the communication paths 114 and 116 can be implemented in accordance with the needs of the individual application and are not limited to any one exemplary embodiment. One of skill in the art will readily recognize the many different embodiments in which system 100 can be implemented, including the various examples described herein. Furthermore, the systems and methods described herein are not limited to just those configurations, techniques and applications known in the art, but can be implemented with any configurations, techniques and applications to be developed or achieve widespread use, including customized and combined versions of the various examples described herein.

The wireless communication system 100 can be any wireless system depending on the needs and location of the individual application. For instance, in one embodiment, the wireless system 100 is a mobile telephony system operating with a wireless standard including Advanced Mobile Telephone Service (AMPS), Code Division Multiple Access (CDMA, CDMA2000), Digital Communication Service (DCS), Enhanced Data GSM Environment (EDGE), General Packet Radio Services (GPRS), Group Special Mobile (GSM), Japan Total Access Communications System (JTACS), North American Digital Cellular (NADC), Nordic Mobile Telephone (NMT), Personal Communications Services (PCS), Personal Digital Cellular (PDC), Specialized Mobile Radio (SMR), Total Access Communications System (TACS), Universal Mobile Telecommunications System (UMTS) and Wideband CDMA (WCDMA).

In another embodiment, the wireless system 100 is used in other forms of wireless communication, including radio, satellite, pager, wireless local loop (WLL), systems using the Industrial, Scientific and Medical (ISM) bands, wireless local area networks (WLAN), wireless wide area networks (WAN) and mobile internet networks. It should be noted that the wireless system 100 is not limited to the preceding exemplary embodiments and can be any wireless system implementing wireless communication between an antenna and a mobile unit. Furthermore, several of the above examples do not require a base station 108 or a wireless network 110 and, accordingly, these elements can be excluded according to the needs of the individual applications.

The communication paths 114 and 116 can be either wireless or wireline and are dependent on the distance of communication and amount of information transferred over the path in the application. Examples of various wireless communication techniques and standards are mentioned above. Examples of wireline connections include, but are not limited to DSO, Integrated Services Digital Network (ISDN), T1, T3, Optical Carrier (OC) 3, OC-12, OC-48 or OC-192 communication formats.

The antenna 102 can be any antenna configured for wireless communication. The type and configuration of antenna 102 is dependent on the individual application. The antenna 102 can be configured for any desired frequency, signal strength and signal gain. The antenna 102 can be omni-directional, multi-directional or uni-directional. The antenna 102 can be a monopole, multi-pole and multi-dimensional antenna, and can also be singular or arrayed, including various smart antenna configurations. The antenna 102 can also be a radio frequency (RF) radiating medium. In one embodiment described below, the antenna 102 is an RF radiating coaxial cable, also referred to as “leaky coax.”

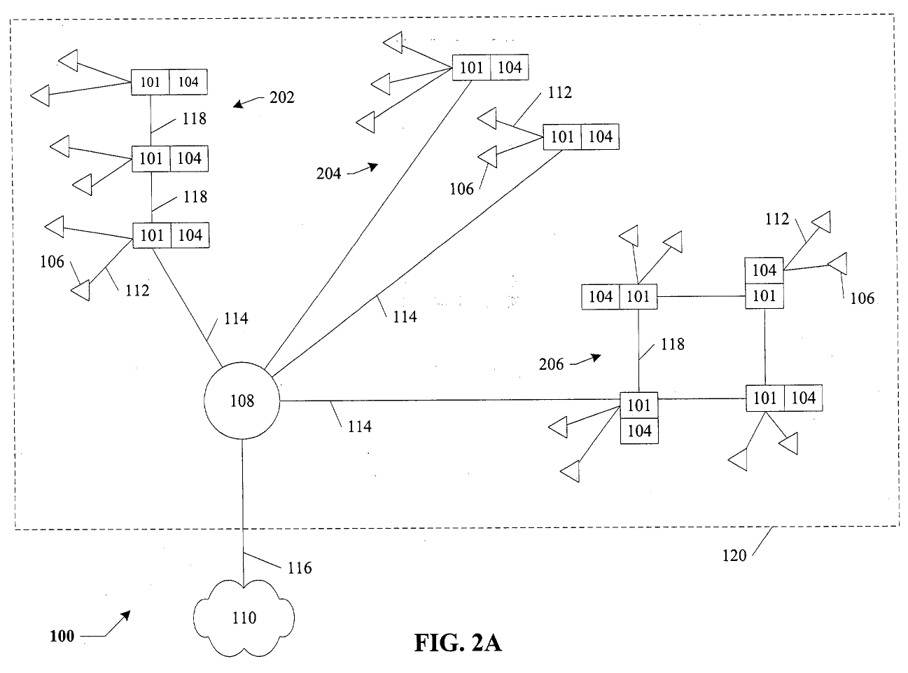

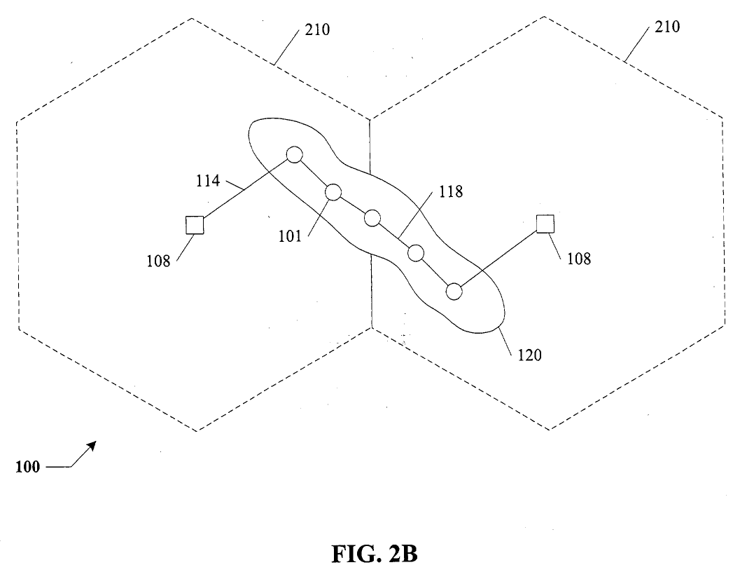

The base communication unit (BCU) 103 is configured to communicate with the base station 108 using any communication standard or protocol in accordance with the application. The BCU 103 can be integrated directly with the electronic hardware of the antenna 102 or can be a separate component communicatively coupled with the antenna 102. The BCU 103 can also be implemented in software to convert the communications relayed between the antenna 102 and the base station 108 into the desired communication protocol. The BCU 103 can also be configured to communicate with other BCU's 103, for instance, as in an embodiment where numerous antenna systems 101 are connected in series, such as in the “daisy chain” configuration depicted in FIG. 2. In one embodiment, antenna system 101 includes the functional capabilities of the base station 108 and communicates directly with the wireless network 110 or an intermediate base station controller, in accordance with the implementation of a typical mobile telephony system.

The wireless device 106 can be any wireless device configured for wireless communication and, accordingly, the type and configuration of the wireless device 106 is dependent on the individual application. The wireless device 106 can be a mobile wireless device or can be in a fixed position. Numerous embodiments of the wireless device 106 are envisioned herein, including, but not limited to a mobile phone, pager, wireless modem, personal digital assistant (PDA), transponder device or transceiver.

The wireless network 110 can be any wireless network configured for wireless communication and having the hardware and software infrastructure for processing a wireless communication. In one preferred embodiment, the wireless network 110 is a wireless service provider that provides wireless service to a broad geographical region. In another embodiment, wireless network 110 is a wireless LAN infrastructure contained within a corporate complex. The wireless network 110, in addition to the other elements of the wireless system 100, can be shared between multiple entities, where the various entities share in the cost, maintenance or implementation of the elements within the wireless system 100.

FIG. 2A depicts another embodiment of a wireless communication system 100, illustrating numerous antenna systems 101 integrated on infrastructure elements 104 and distributed throughout an impeded region 120. Also depicted are numerous wireless devices 106 in communication with antenna systems 101 over the wireless communication paths 112. In this embodiment, antenna systems 101 communicate with the base station 108 both serially and in parallel. The antenna systems 101 are distributed in a serial configuration 202, which is also referred to as a “daisy chain.” In the serial configuration 202, the BCU's 103 are configured to communicate with other BCU's 103 in the chain and information is relayed from one BCU 103 to the next over the communication paths 118, which can be either wireless or wireline. In this configuration 202, each BCU 103 is configured to relay information between the antenna 102 and the base station 108, as well as the information coming from or going to each other antenna system 101 in the chain.

Also depicted in FIG. 2A is a parallel configuration 204, where the antenna systems 101 directly communicate with the base station 108. In the parallel configuration 204, each BCU 103 can be configured solely for communication with the base station 108 and is not required to communicate with other BCU's 103. A ring configuration 206 is yet another exemplary embodiment of the distribution of antenna systems 101 within the region 120. The BCU's 103 within the ring configuration 206 are configured to communicate with other BCU's 103, similar to the serial configuration 202. A ring configuration 206 can relay communications in two or more directions, thus allowing the ring to maintain communication with all the antenna systems 101 in case one communication path 118 is lost or damaged. One of skill in the art will readily recognize the advantages of each of the configurations 202-206, as well as the ability to combine aspects of each configuration to fit the needs of a desired application. Furthermore, one of skill in the art will readily recognize that system 100 can be implemented in any configuration and accordingly, the system 100 is not limited only to the configurations 202-206 disclosed herein.

As depicted in FIG. 2A, numerous wireless devices 106 are communicatively coupled with the antenna systems 101. In one embodiment, the various wireless devices 106 are mobile devices, such as a mobile phone. The wireless system 100 is configured to communicate with the mobile phone 106 as the mobile phone 106 transitions between both the antenna systems 101 within the region 120 and antennas in adjacent non-impeded regions. To facilitate this transitional environment, the antenna systems 101 can be configured to “hand off” or transfer the communication path 112 with the mobile phone 106 to other antenna systems 101 within the system 100, preferably without noticeable service interruption. Furthermore, the base station 108 is preferably configured to maintain communication during a handoff involving an adjacent base station 108, for instance, as demonstrated by the case where an antenna system 101, in communication with one base station 108, hands off the communication to a second antenna system 101 in communication with a second adjacent base station 108. The various methods of “handing off” wireless communications are readily known in the art.

The region 120 can be any region or area where wireless coverage is impeded. The impedance of wireless coverage can be caused by any factor, whether it is social, political or geographical in nature. A geographical impedance can be either naturally-occurring or man-made. For instance, one example of an impeded region 120 is a canyon where standard vertical antenna structures are placed on either side of the canyon. These vertical structures provide wireless coverage around the canyon, but tend to propagate ineffectively into the canyon itself due to the geographical interference created by the canyon walls. Another example of an impeded region 120 is an urban area, where the presence of buildings and high-rises impede the propagation of wireless signals. Geographical impedances are not, however, limited to wide fluctuations in elevation or vertical obstructions. A geographical impedance can also be found in a desert, where demand is such that wireless coverage is needed over only a limited area in proximity to a road. In this case, the use of vertical towers is inefficient because of the balance between cost and the presence of wireless coverage over large areas where it may not be needed.

Another type of impeded region 120 is a region where political or regulatory restrictions exist that impede the construction of vertical towers or other antenna structures. For instance, in historic areas, urban, residential and the like, strict regulations exist limiting construction of antenna structures in order to preserve historic appearances. In parks, wildlife refuges and other “green spaces,” antenna construction is restricted in order to preserve the sanctity and undeveloped nature of the region. Another example is a typical local zoning provision enacted to limit the construction of antenna structures due to the undesired appearance of the structures and possible decline in property values. Yet another example is a region where wireless coverage is restricted only to certain areas, due to the existence of sensitive equipment, such as airports, research universities or military installations.

Wireless coverage in the region 120 can also be impeded by social concerns. Antenna structures are typically not considered very aesthetic in appearance and there is a common resistance to the erection of new structures due to this factor. Also, concerns over the health of those living or working in proximity to the radio frequency energy emitted by the antenna can effect the decision to construct or operate new antenna structures, in which case a desired solution can be found in using a higher quantity of lower power antennas, which is contemplated by the systems and methods herein.

FIG. 2B further demonstrates the ability of the optimized wireless system 100 to provide wireless coverage over a wide range of impeded regions 120. FIG. 2B depicts an embodiment where optimized wireless system 100 can be used in conjunction with, or in addition to, one or more base stations 108, to increase wireless coverage. For instance, to provide wireless coverage over a desired area, base stations 108 are distributed over the area at pre-determined intervals that attempt to balance both the range and coverage capabilities of each base station 108 with the associated costs of purchasing, manufacturing or installing each base station 108. In some cases, this balance can result in one or more regions that experience reduced quality of service, i.e., one or more wireless impeded regions 120. This can occur either because these regions 120 are not within the range of a base station 108 or because the propagation of wireless signals into that region 120 is impeded. As mentioned above, these regions 120 can be urban, rural, residential, or the like, and the wireless service can be impeded by geographical, political or social factors and concerns. Here, region 120 is depicted as being within regions 210 but one of skill in the art will readily recognize that any part of or the whole of region 120 can be located within or outside of any region 210.

Here, two base stations 108 provide wireless coverage over wireless service regions 210, which represent the optimum range in which wireless communication can be performed without significant effects on performance. These base stations 108 are preferably connected to a wireless network 110, which can be part of a mobile telephony service, paging service or the like. In this embodiment, wireless coverage into the region 120 is impeded despite the fact that the entire region 120 is located within the range of at least one of the base stations 108. To provide coverage into this region 120, antenna systems 101 are integrated with infrastructure elements 104 (not shown) and distributed throughout the region 120. The range and capabilities of each antenna system 101 can be configured to provide wireless coverage over only those parts of regions 120 where it is needed. A determination of where coverage is needed depends on the individual application. The antenna systems 101 are communicatively coupled together over wireless paths 118, and communicate with each base station 108 over communication path 114. In this manner, wireless coverage can be provided into any region 120 within a broader service region 210 by the use of an optimized wireless systems 100 in conjunction with the base station 108 by balancing the cost with the coverage capabilities of each.

Referring back to FIGS. 1 and 2A, the infrastructure element 104 can be any structure, device, component or system within the region 120 that can be integrated with the antenna 102. The infrastructure element 104 can be a pre-existing element of the region 120 or can resemble an element the existence of which is acceptable or allowable in the region 120. The infrastructure element 104 can also be a device integratable with a pre-existing element of the infrastructure of the region 120. The following examples facilitate the illustration of the broad range of embodiments the infrastructure element 104 can assume.

In one exemplary embodiment, the region 120 can be a canyon, mountain pass, desert, residential area and the like, and the infrastructure element 104 is a traffic-bearing reflector integratable with a pre-existing road passing through the region. The antenna system 101 is integrated with the reflector and coupled to the base station 108 by a communication line 114, buried in or near the roadway. Multiple antennas 102 and the reflector 104 are distributed along the road at desired intervals to provide wireless coverage along the span of road which passes through the region.

In another exemplary embodiment, the region 120 is a historical area where free-standing antenna structures are restricted from use, but window mounted air-conditioning units are permitted. In this example, the infrastructure element 104 is a housing configured to resemble a window mounted air-conditioning (AC) unit and the antenna system 101 is integrated within the housing. The housing is mounted on a window on the side of a building in a manner similar to that of an actual AC unit, and wireless coverage is provided by the antenna system 101 within the housing 104. The antenna system can communicate wirelessly with a base station 108 located outside the historic region 120.

In yet another exemplary embodiment, the region 120 can be a residential neighborhood where the residents are not receptive to the construction of a vertical antenna structure, or region 120 can be a canyon, mountain pass and the like where wireless coverage is impeded. In this example, the infrastructure element 104 is a telephone pole and the antenna 102 is a leaky coax cable. The leaky coax 102 is distributed along a span of telephone poles 104 through the region 120 in a manner similar to a typical telephone or power line. The leaky coax cable 102 is connected to a base station 108 located away from the region 120 and wireless coverage is provided by the leaky coax cable 102 throughout the region 120 without the use of a vertical antenna structure. Similarly, in one alternative embodiment, the leaky coax 102 is integrated in a shallow trough within a road running through the region 120. In another embodiment the leaky coax is integrated with a center lane divider or guard rail running along the road through the region 120.

It should be noted that the preceding exemplary embodiments are just several of many embodiments of the infrastructure element 104 that are contemplated by the systems and methods described herein. For example, the antenna 102 can be integrated with a metallic or concrete guardrail along a bridge or roadside, integrated within a road or bridge itself or integrated and distributed on one or more lamp posts. While in some embodiments, infrastructure element 104 may resemble a pre-existing infrastructure element, such as with the AC unit housing, in other embodiments, infrastructure element 104 can be a multi-use element, i.e., an element that serves a use in addition to providing a basis for an antenna 102. For instance, a lamp post that includes a functioning lamp and an antenna system integrated within is just one example of a multi-use element that provides light and optimized wireless coverage. The infrastructure element 104 is not limited to man-made elements but can also include naturally-occurring elements such as trees, canyon walls and the like.

As is demonstrated by the preceding examples, the infrastructure element 104 is preferably integrated with the antenna 102 in a manner that substantially conceals the antenna 102, or blends the antenna 102 in with the surrounding environment. The antenna 102 is substantially concealed when a portion of the antenna is obstructed from view so as to fit the needs of the individual application. In many embodiments complete concealment is not required by the application and the antenna is left in a viewable position, for instance, as shown in the telephone pole example. In that example the antenna 102 blends with the surrounding environment because the antenna 102 is a wire similar in appearance to other wires distributed on the pole.

By integrating the antenna 102 with a pre-existing infrastructure element 104, the system 100 utilizes infrastructure already in place throughout the impeded region 120 and does not require significant new construction. Infrastructure element 104 can be integrated with the antenna 102 an by retrofitting the element 104 already in place, such as by distributing the leaky coax 102 along telephone poles. Conversely, the antenna 102 can be integrated with the infrastructure element 104 prior to being put into place, as in the reflector example where the antenna 102 is integrated with the reflector 104 prior to positioning the reflector in the road. This integration can be performed when the infrastructure element is fabricated, or it can be performed after fabrication prior to positioning. The system 100 can also be implemented by adding infrastructure elements 104 that resemble pre-existing infrastructure elements 104, such as with the above AC unit housing 104 example.

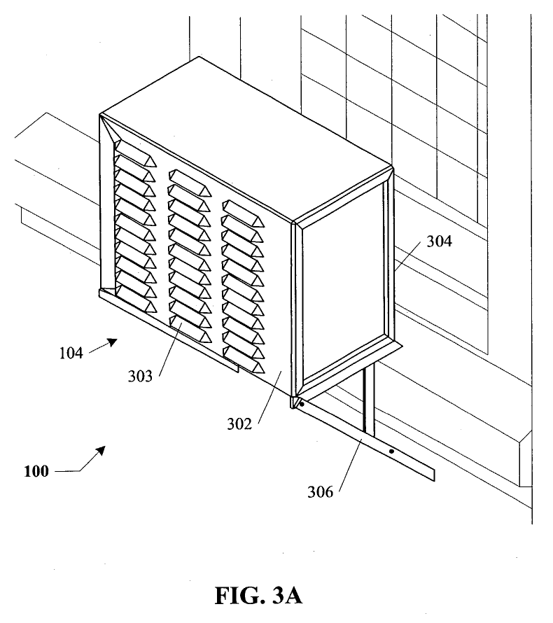

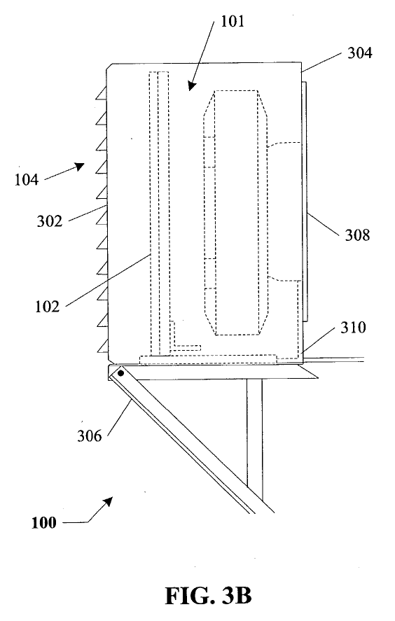

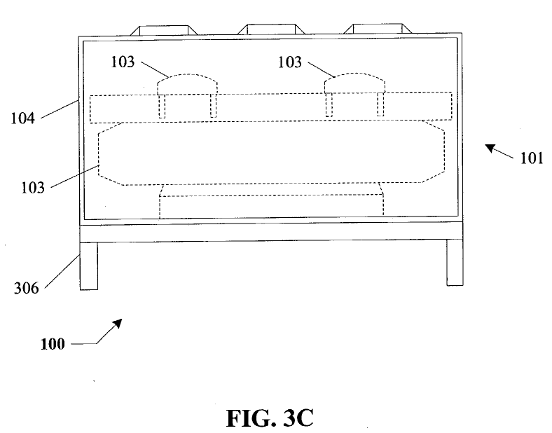

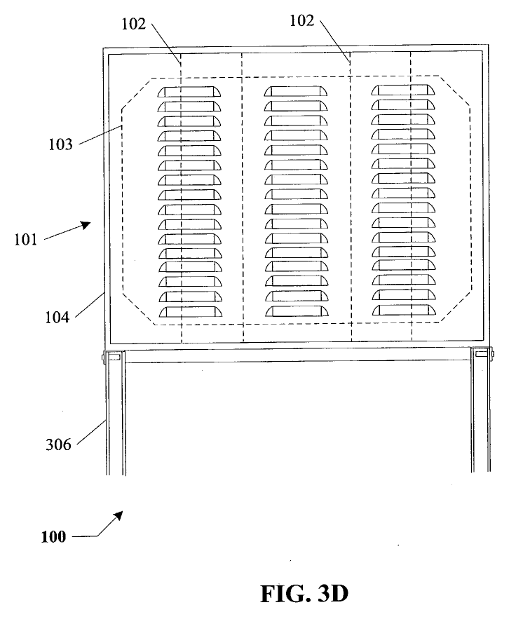

FIGS. 3A-D depict one exemplary embodiment of the system 100 where the antenna system 101 is integrated with a housing 104 configured to resemble a typical window-mounted AC unit. It should be noted that an AC unit is only one example of numerous embodiments of infrastructure elements housing 104 can be configured to resemble. Other examples include, but are not limited to a heating unit, water heater, ventilation duct, chimney, light post, gas lamp, guard rail, skylight and the like. In this embodiment, housing 104 is used within wireless impeded region 120, which is a historic district where regulations restrict the presence of antenna structures. Historic region 120 can be either rural or urban, for instance in some rural historical areas, such as historic villages, towns, parks, forts and missions, conventional infrastructure elements tends to be limited to basic necessities such as AC units, water pumps, toilet facilities and the like. The same restrictions can apply in more urbanized historical regions, although the range of restricted infrastructure elements tends to be relatively more narrow. Accordingly, housing 104 can be implemented in any area where regulatory, aesthetic, geographic or social concerns limit the presence of a conventional antenna structure.

FIG. 3A depicts a perspective view of the exterior of the housing 104 and support brace 306 configured to mount housing 104 on a building. The antenna system 101 is located within the housing 104 and is not shown. The front side 302 of the housing 104 includes ventilation ducts 303, which preferably resemble the ducts of a typical AC unit. The ducts 303 can also be configured to allow air to flow to the interior of the housing 104 to cool antenna system 101. The support brace 306 is coupled with the housing and the side of the building in order to provide support. The support brace 306 can also be configured to resemble a typical AC unit support brace, if desired.

FIG. 3B depicts a cutaway side view of the housing 104 showing the antenna 102 and the BCU 103 within. In this embodiment, the antenna 102 is adjustable to optimize coverage in a particular direction or region. The antenna 102 is preferably adjustable in both vertical and horizontal directions and can be tilted and panned vertically and horizontally within the housing 104. The antenna 102 can be either manually or automatically adjusted. In one embodiment, the antenna 102 is automatically adjusted by an electromechanical actuator (not shown). The actuator can be operated remotely in order to adjust the antenna 102 without having to send technical personnel to the antenna site.

In one embodiment, a technical person accesses the antenna site via an internet connection and a user interface. The interface provides the operator with the current directional settings of the antenna 102 and allows the operator to adjust the settings to optimize wireless coverage. The technical person makes an antenna adjustment at a particular antenna site and the user interface relays this remote adjustment command to the actuator, which implements the new setting. New settings are conveyed to the actuators through the BCU 103 and the antennas are adjusted accordingly. Positional feedback can be provided to the technical person through a visual or electronic sensor in place in order to ensure the new settings are actuated properly. Remote adjustments can be made in real-time to allow antenna 102 to optimize coverage according to temporal variations in wireless traffic. For instance, in a highly populated urban region, antenna 102 can be adjusted towards a commercial area of the region during typical weekday working hours and then towards a residential area in the evening and at night.

The housing 104 includes an electromagnetic force (EMF) shield 308 located on a back side 304. EMF shield 308 is configured to substantially prevent transmission of electromagnetic energy towards the building. The shield 308 protects building occupants from the EMF propagating from the antenna 102, as well as other system 100 components. In many applications, the presence of an EMF shield 308 is required by federal communications commission (FCC) guidelines. Preferably, the shield 308 is fabricated from an RF non-permeable material that reduces the amount of electromagnetic energy permeating the shield to a safe level, preferably a level determined by a relevant regulatory agency such as the FCC. In one preferred embodiment, the shield 308 is fabricated from a metallic material and is coupled with a ground source.

Also shown in this embodiment is a power supply connection 310 that supplies power to the antenna system 101. Preferably, the antenna system 101 is configured to operate with a standard power supply, such as that determined by an energy regulating body. The use of a standard power supply eliminates the need to generate or route power separate from that within the building. The standard supply also eliminates the need for additional transformer electronics. One example of a standard power supply is 110 volt (v) supply typically found in residential and commercial wall outlets throughout the United States. Because power supply standards vary by region and nation, the planned location should be considered in the design and implementation of system 100. However, the system 100 is not limited to standard supplies and any supply can be used.

FIGS. 3C and 3D depict a cutaway top view and a cutaway front view of the system 100, respectively, each depicting an antenna system 101 within the housing 104. The housing 104 is preferably fabricated from one or more radio frequency (RF) permeable materials, such as non-metallic materials, that allow RF energy to pass through without degradation or interference affecting the proper function of system 100. The frequency of RF energy allowed to permeate the housing 104 is dependent upon the application, for instance, if the system 100 implements a cellular standard of communication, the RF energy passing through the housing 104 will typically be in the range of 800-900 Megahertz (Mhz). The housing 104 is preferably configured to allow a wide range of RF frequencies to permeate in order to facilitate multiple communication standards or methods.

The housing 104 can be configured to adapt to the various needs of the numerous applications in which the system 100 can be implemented. For instance, in one embodiment, the antenna system 101 is housed partially within the housing 104 and partially external to the housing 104. The housing 104 can also be configured for the differing types of communication between the BCU 103 and other elements of the system 100. For instance, if the communication path 118 is an optical path, the housing 104 can include an opening or optically transparent surface to allow optical energy to pass. The housing 104 can be configured to include additional systems such as power generation systems, cooling systems, robotic systems, actuator systems and any other system needed by the application. In one embodiment, the housing 104 houses an antenna system 101 as well as an AC unit to provide air-conditioning to the building. One of skill in the art will readily recognize the functional and operational flexibility of the housing 104 and the ability of the housing 104 to be adapted for numerous desired applications.

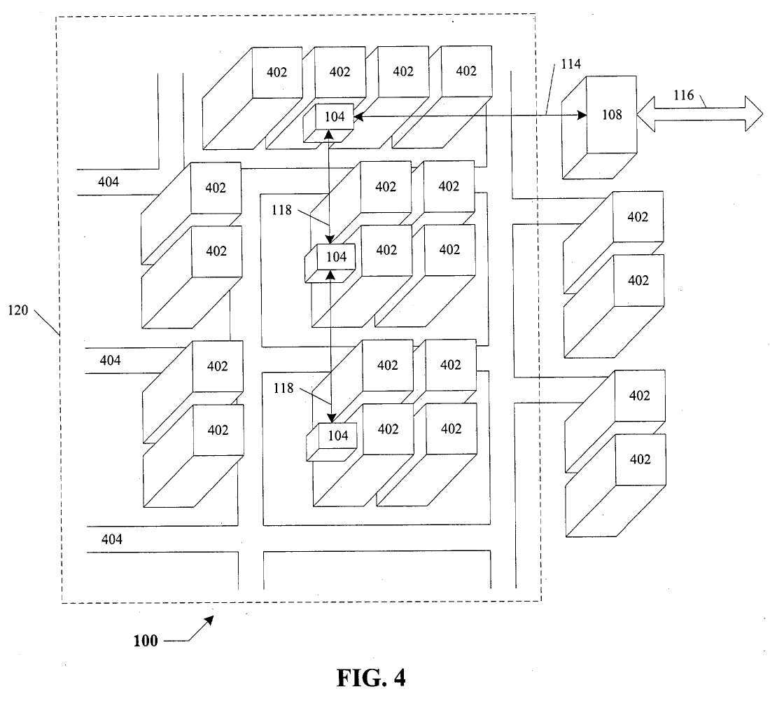

The BCU 103 is communicatively coupled with the antenna 102 and provides a communicative link with elements within the system 100. As depicted in FIG. 2, the system 100 can be distributed in various configurations and the BCU 103 can be configured to communicate in accordance with each configuration. In one embodiment, the BCU 103 is configured to communicate directly with each of the elements of the system 100, such as the base station 108, the wireless network 110 and other antenna systems 101. FIG. 4 depicts another embodiment of the system 100, where multiple antenna systems 101 (not shown) are integrated within housings 104 and mounted on buildings 402 along roadways 404 within the region 120. The system 100 is located in and around the region 120. To facilitate the illustration of the numerous features of system 100, in this exemplary embodiment, the region 120 is depicted as a densely populated urban area, which typically is not conducive to the use of multiple vertical antenna structures. It should be noted, however, that region 120 can be any wireless impeded region, alone or in combination, such as a historic, residential, rural, or urban area and the like. Historic regions 120 are often regulated by governmental regulations or regulatory provisions that restrict the presence of vertical antenna structures. Preferably, housing 104 is configured to resemble an AC unit which is typically not regulated.

This embodiment of the system 100 allows wireless coverage in the urban region 120 and facilitates coverage within the dense array of buildings 402. In this embodiment, antenna systems 101 within each housing 104 are in a daisy chain configuration 202 and each antenna 102 communicates with one or more wireless devices 106 (not shown) located throughout the region 120. Each antenna system 101 within the housing 104 includes a BCU 103 which is configured to communicate with another system 101 or a base station 108. In this embodiment, the communication path 118 is preferably a wireless communication path, such as an RF path or an optical path.

In one embodiment, communication path 118 is a microwave backhaul connecting each of the antenna systems 101 and terminating at the base station 108. The base station 108 can then communicate with the wireless network 110 over the communication path 116, which, in this embodiment, is a T1 or T3 line. Here, the need for a T1, T3 or other wireline communication path to each antenna system 101 is eliminated allowing increased flexibility in the design and implementation of system 100. Also in this embodiment, a clear line of sight exists between the housings 104, which is preferable in embodiments employing optical communication such as a laser communication gateway. However, a clear line of sight is not required for the operation of the system 100 and can be excluded depending on the needs of the application.

One of skill in the art will readily recognize that the housing 104 can be placed at varying heights on the side and top of the building 402, allowing flexibility in the scope and direction of wireless coverage. Furthermore, multiple antenna systems 101 can be placed on buildings 402 at any interval, preferably so long as the communication range of each individual antenna system 101 is not exceeded. This allows the cost-effective placement of the housings 104 throughout region 120. For instance, the antenna system 101 and the housing 104 can be placed at the lowest cost position on a given building 402 within range of another system 101 also placed at the lowest cost position on that given building 402, even if the positions are at different heights lacking a clear line of sight. Considerations to be considered in optimizing placement of the antenna systems 101 include the cost of leasing window space, the amount of wireless traffic surrounding the system 101 and the range of the antenna 102.

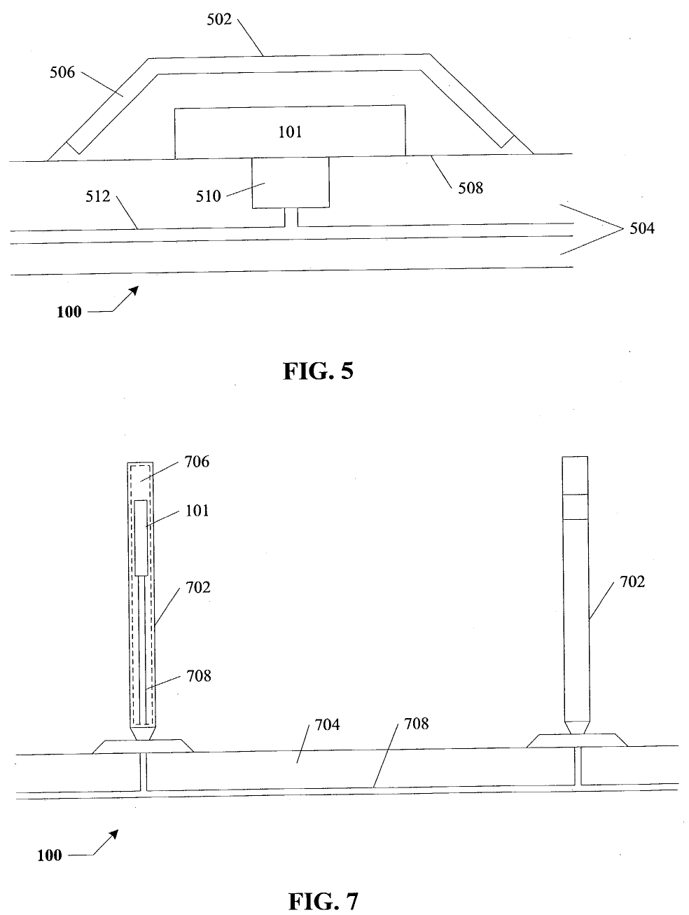

FIG. 5 depicts another exemplary embodiment of the system 100, where the infrastructure element 104 is a reflector and the impeded region 120 can be a geographically impeded region such as a canyon, mountain pass, desert and the like, or some other region, such as a residential neighborhood, where vertical structures are restricted. The antenna system 101 is preferably integrated with the raised road reflector 502 and embedded within a road 504 that passes through the impeded region 120. In this embodiment, the antenna system 101 is integrated in a cavity within the reflector 502, which, in this embodiment, is a raised road reflector. The raised reflector 502 includes one or more reflective surfaces 506 and is configured to be embedded in a road 504. The reflector 502 includes a plug 510 which is placed in a cavity within the road 504. In other embodiments, the reflector 502 can be attached to the road with an adhesive 508 used by itself or in combination with the plug 510.

The antenna 102 and the BCU 103 are integrated within the reflector 502 and can communicate with other BCU's 103 or the base station 108 (not shown) using the signal line 512. The signal line 512 can be put into place prior to construction of the road 502 or can be installed using a trenching technique commonly known in the art. In this embodiment, the line 512 also supplies power to the system 101. Since the reflector 502 and the antenna system 101 are used on a road 504, both are preferably configured to bear the weight and impact of road traffic. Design and fabrication of traffic bearing elements is readily apparent to one of skill in the art. The reflector 502 is preferably fabricated from an RF permeable material and is configured to allow the wireless signals to pass through without degradation or interference sufficient to prevent proper wireless communication over the path 112. Antenna systems 101 can be placed at any interval that provides the desired wireless coverage in the region 120.

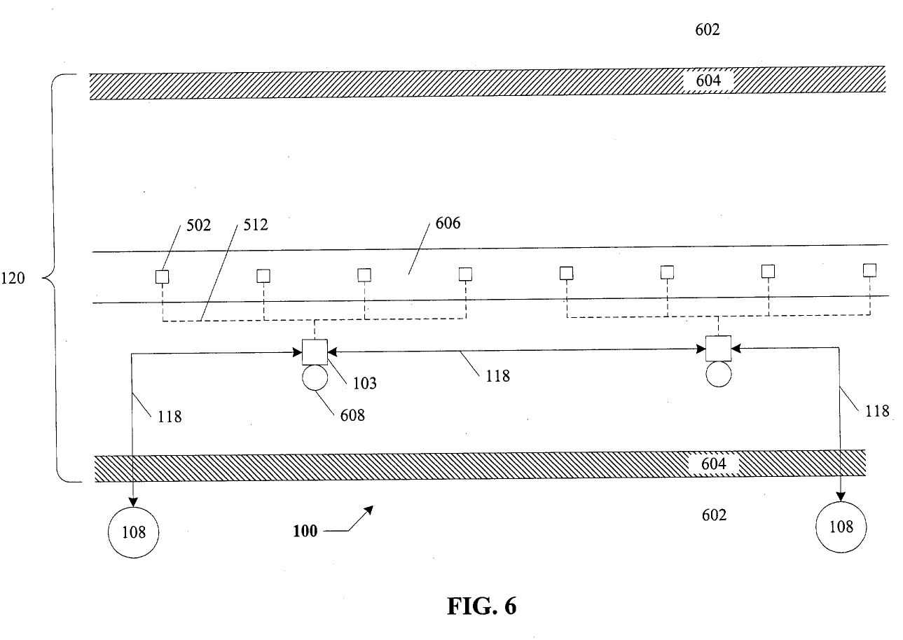

FIG. 6 depicts an embodiment of system 100 located in a canyon base 120, below elevated region 602 and between canyon walls 604. An antenna 102 (not shown) is integrated within an infrastructure element 104, which in this embodiment is a reflector 502, and communicates with a BCU 103 located in a remote position along a road 604. The BCU 103 is configured to communicate with multiple antennas 102 distributed throughout the region 120 using line 512, which is preferably located underground. Each BCU 103 is integrated with a second infrastructure element 104, which in this embodiment is a telephone pole 608. Communications are relayed between multiple BCU's 103 through communication path 118. In this embodiment, wireless coverage is provided through canyon base 120 along road 606 by using pre-existing telephone poles 608 and newly added reflectors 502.

In one embodiment, an antenna system 101 operates using a low voltage, that is less than a standard 110 volt power supply, and is connectable to a line 512 through a semi-insulator sheath surrounding the line 512. The antenna system 101 can be coupled to a power supply or can communicate with other elements of the system 100 or both, through the line 512. In this manner, the line 512 does not have to make a direct electrical connection with the system 101. Furthermore, this embodiment facilitates the connection of the antenna system 101 to the line 512 and does not require expensive connection circuitry or create the risk of corrosion of the inner conductive core of the line 512. A coupling device, such as a clamp or crimpable ring, are preferably used to connect the system 101 with the line 512. One of skill in the art will readily recognize that these systems and methods for low voltage coupling are not limited to this road reflector embodiment and can be used with any of the embodiments described herein.

FIG. 7 depicts another embodiment of the system 100 where an infrastructure element 104 is a guard post 702 along a road 704 in a wireless impeded region 120. In this embodiment, the guard post 702 is a flexible guard post configured to bend and give way if a traffic vehicle comes into contact with the post. The region 120 can be a construction site where the guard posts 702 are placed along the road 704, which, for instance, can be a dirt road. In addition, region 120 can be a residential or rural area where guard posts 702 are place along the side of the road to facilitate negotiation of the road at night or during inclement weather and the like. The antenna system 101 is integrated within a hollow cavity 706 within the post 702 and is preferably insulated against a traffic vehicle impact. The antenna system 101 can be placed at varying heights within the post 702 in order to optimize coverage.

The antenna system 101 is communicatively coupled with other systems 101 or the base station 108 by the communication line 708, which is preferably embedded within the road 704. Antenna systems 101 can also communicate wirelessly without the line 708, which can be preferably if the dirt road 704 is prone to erosion. In another embodiment, posts 702 are distributed along roads in the region 120, which is, for instance, a residential area. The antenna system 101 is integrated within each post 702 or only some posts 702 at intervals along the road. The antenna systems can be configured as wireless signal repeaters communicatively coupled to one or more base stations 108 located outside the region 120, similar to the embodiment depicted in FIG. 2A. In this manner wireless coverage can be increased in the residential region 120, which can also be any region 120 such as an urban or rural area. Also, the antenna system 101 can be implemented using the low voltage coupling systems and methods described above.

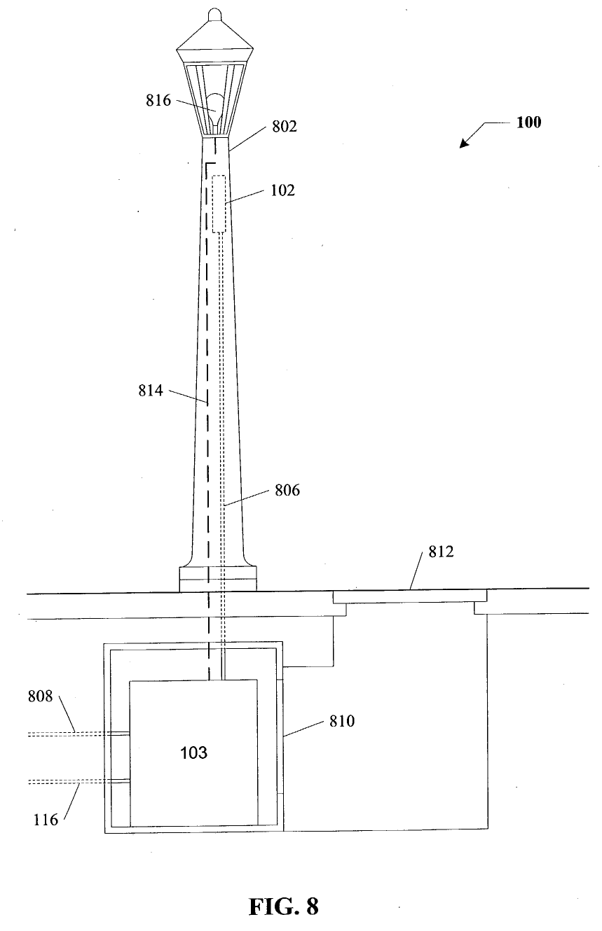

FIG. 8 depicts another embodiment of the optimized wireless system 100, where the infrastructure element 104 is a lamp post 802 within the impeded region 120, which can be a residential neighborhood, historic district or the like. This embodiment is configured for an application where the antenna system 101 is preferably concealed entirely from view. Therefore, the antenna 102 is integrated within the lamp post 802 and communicatively coupled through the communication line 806 with the BCU 103, which is located under the ground beneath the lamp post 802 in a subterranean vault 804. The vault 804 can be fabricated from any material according to the needs of the application, such as concrete or steel. The antenna 102 can be positioned at any height within the lamp post 802 to optimize coverage. Also, the antenna system 101 can be implemented using the low voltage coupling systems and methods described above.

The BCU 103 is communicatively coupled with the wireless network 110 via the communication line 116, and can be powered by the power supply line 808. Access to the vault 804 is provided by an access port 810, which can be accessed by an entrance 812 located in a sidewalk or located remotely from the vault 804. The entrance 812 can also be obtained in any manner in accordance with the needs of the application, such as through a storm sewer or gas meter holding pen. The vault 804 can also include any cooling systems, power generation systems, and computing systems needed in the application. Other embodiments of the infrastructure element 104 can include a flagpole, sign post, or an artificial tree or cactus. In this embodiment, the lamp post 802 preferably remains in workable condition and provides light in addition to serving as a basis for the antenna 102. To do this, the lamp post 802 can include a power line 814 to supply power to a functioning light 816. The power source for light 816 can be routed through BCU 103 or can be routed directly from a separate line within the sidewalk or street.

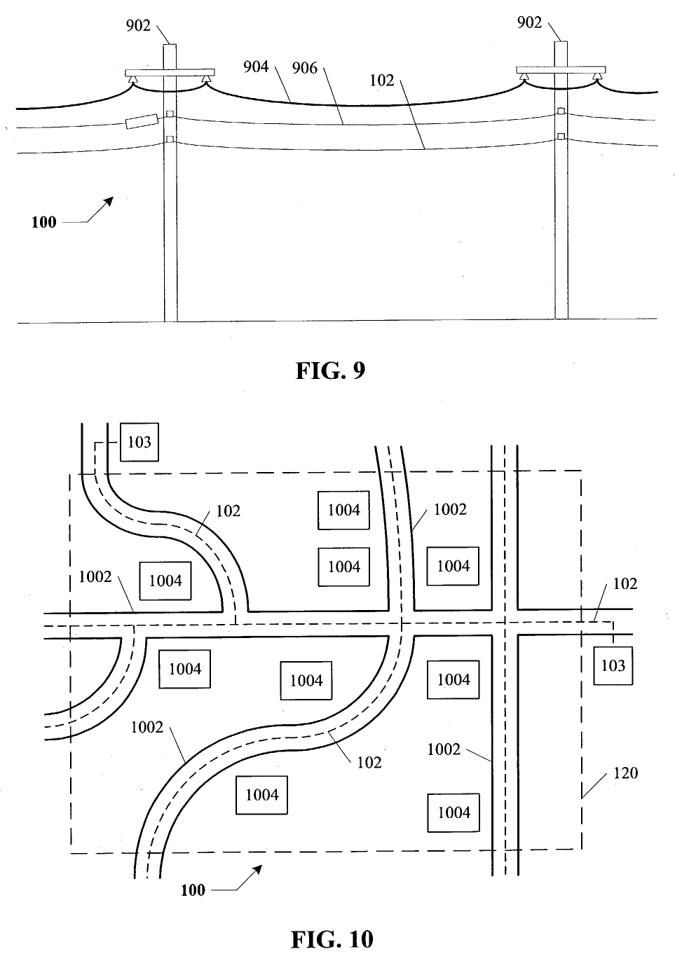

FIG. 9 depicts an additional embodiment of a system 100 where an antenna 102 is an RF radiating cable, otherwise referred to as leaky coax. Any type of leaky coax 102 can be used, including coupled-mode or radiating-mode cable. The leaky coax 102 can also be configured for the wireless frequency range used by the system 100. In one embodiment, perforations in an outer conductor of the cable 102 and the size of the cable 102 are configured to allow a pre-determined amount and frequency of RF energy to radiate from within. To prevent against corrosion in an outdoor environment, the cable 102 can be within an RF permeable sheath that does not substantially interfere with the wireless communications within the system 100.

In the embodiment depicted in FIG. 9, the leaky coax 102 is distributed along multiple telephone poles 802, which are embodiments of the infrastructure element 104. The telephone pole 902 is preferably pre-existing and used by a utility to provide electricity, telephone service etc. In this embodiment, a power line 904 and a telephone line 906 are distributed on poles 902. By using pre-existing telephone poles 902, the system 100 allows wireless coverage in a region 120 with minimal installation costs. Also, the telephone poles 902 are preferably along a span of road or other area where wireless devices 106 are prevalent. In the instance where the region 120 is a desert or canyon, the majority of wireless communication takes place along roads from, for example, the use of a mobile phone 106 within a vehicle. Therefore, by utilizing the pre-existing telephone pole 902, wireless coverage can be provided in a quick and cost-effective manner over a region 120 where wireless communication is prevalent.

FIG. 10 depicts another embodiment of the optimized wireless system 100, where the leaky coax 120 is integrated with a road 1002 and distributed through the wireless impeded region 120, which can be a residential neighborhood, recreation park and the like. The leaky coax 102 is communicatively coupled between two of the BCU's 103, which are base stations that provide inadequate wireless coverage in and around the region 120. This can be due to numerous factors, such as the distance from region 120 to BCU's 103, or interference caused by the presence of the houses 1004 or other geographical impedances such as elevational changes within region 120. The leaky coax 102 can be distributed in a shallow trench before or after construction of the road 1002 or prior to resurfacing etc. In this embodiment, wireless system 100 can be a wireless service provided by multiple service providers and the leaky coax 102 distributed throughout region 120 is shared by the multiple carriers. This eliminates the need for multiple carriers to install or purchase separate systems 100 that provide redundant coverage in region 120. It should be noted that other embodiments of infrastructure element 104 can be used in region 120 as well, including reflector 502 and telephone pole 902. Although this embodiment is illustrated with reference to leaky coax 102, other embodiments of antenna system 101 can also be used, such as antenna system 101 coupled with a reflector 502, guard post 702 or lamp post 802. Also, the antenna system 101 can be implemented using the low voltage coupling systems and methods described above.

In the foregoing specification, the invention has been described with reference to specific embodiments thereof. It will, however, be evident that various modifications and changes may be made thereto without departing from the broader spirit and scope of the invention. For example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A method for optimizing a wireless communication system, comprising:
integrating an antenna with an infrastructure element in a region where wireless communication coverage is impeded;
communicatively coupling the antenna with a wireless network.

2. The method of claim 1, wherein the wireless communication coverage is impeded by a structure interfering with propagation of a wireless signal.

3. The method of claim 2, wherein the structure is naturally occurring.

4. The method of claim 2, wherein the structure is man-made.

5. The method of claim 1, wherein the wireless communication coverage is impeded by regulatory restrictions.

6. The method of claim 5, wherein the regulatory restrictions restrict the use of a vertical antenna structure.

7. The method of claim 1, wherein the infrastructure element is a pre-existing infrastructure element.

8. The method of claim 7, wherein integrating comprises coupling the antenna with the pre-existing infrastructure element.

9. The method of claim 7, wherein integrating comprises substantially concealing the antenna from view.

10. The method of claim 1, wherein the antenna is a radio frequency (RF) radiating cable.

11. The method of claim 1, wherein integrating the antenna comprises communicatively coupling the antenna with a base communication unit.

12. The method of claim 11, further comprising communicatively linking the base communication unit with the wireless network.

13. The method of claim 12, further comprising communicatively linking the base communication unit and the wireless network with a base station configured to relay communications between the base communication unit and the wireless network.

14. The method of claim 10, wherein the infrastructure element is a guardrail located along a road and the RF radiating coaxial cable is integrated with the guardrail.

15. The method of claim 10, wherein the regional infrastructure element is a telephone pole and the RF radiating coaxial cable is integrated with the telephone pole.

16. The method of claim 10, wherein integrating further comprises distributing the RF radiating cable within the region.

17. The method of claim 1, wherein the infrastructure element is a road and the antenna is integrated with a reflector in the road.

18. The method of claim 1, wherein the infrastructure element is a housing configured to resemble an air-conditioning (AC) unit and the antenna is integrated within the AC unit.

19. An optimized wireless communication system, comprising:
a housing configured to resemble an air-conditioning (AC) unit;
an antenna integrated with the housing, the antenna configured for wireless communication with a wireless device and communication with a wireless network.

20. The system of claim 19, wherein the housing is configured to resemble the exterior of an AC unit.

21. The system of claim 19, wherein the housing is mountable on the side of a building.

22. The system of claim 21, wherein the housing comprises a first side configured to face the building.

23. The system of claim 22, wherein the first side comprises an electromagnetic force shield configured to substantially prevent transmission of electromagnetic energy towards the building.

24. The system of claim 23, wherein the shield is fabricated from an RF non-permeable material.

25. The system of claim 24, wherein the shield is fabricated from a metallic material and is coupled with a ground source.

26. The system of claim 1, wherein the housing is fabricated from a radio frequency (RF) permeable material.

27. The system of claim 26, wherein the RF permeable material is non-metallic.

28. The system of claim 1, wherein the antenna is coupled with a power supply.

29. The system of claim 28, wherein the power supply is a standard power supply.

30. The system of claim 29, wherein the power supply is a 110 volt standard power supply.

31. The system of claim 1, further comprising a base communication unit communicatively coupled with the antenna and the wireless network, wherein the base communication unit is configured to provide a communication link between the antenna and the wireless network.

32. The system of claim 31, wherein the base communication unit is communicatively coupled with a base station communicatively coupled with the wireless network.

33. The system of claim 32, wherein the base communication unit is configured to communicate wirelessly with the base station.

34. The system of claim 33, wherein the base communication unit is configured for optical communication with the base station.

35. The system of claim 34, wherein the base station is coupled with the wireless network with a T1 line.

36. The system of claim 21, wherein the housing is mountable near a window.

37. The system of claim 36, further comprising a brace configured to mount the AC unit with the building.

38. The system of claim 1, wherein the housing is configured to resemble an AC unit in permitted by a regulatory provision.

39. The system of claim 1, wherein the antenna is remotely adjustable.

40. The system of claim 39, wherein the antenna is horizontally and vertically adjustable.

41. The system of claim 40, further comprising an actuator coupled with the antenna and configured to adjust the antenna.

42. The system of claim 41, wherein the actuator is configured to adjust the antenna in response to a remote adjustment command.

43. The system of claim 42, wherein the antenna is remotely adjustable to optimize antenna coverage in a densely populated area.

44. An optimized wireless communication system, comprising:
an antenna, integratable with an infrastructure element located in a region where wireless coverage is impeded; and
a wireless network communicatively coupled with the antenna.

45. The system of claim 44, wherein the antenna is configured to communicate with a wireless device.

46. The system of claim 45, wherein the antenna is substantially concealable.

47. The system of claim 45, further comprising a base communication unit coupled with the antenna and configured to provide a communication link between the antenna and a wireless network.

48. The system of claim 44, wherein the antenna comprises a radio frequency (RF) radiating cable.

49. The system of claim 48, wherein the cable is distributed in the region.

50. The system of claim 49, wherein the infrastructure element is a guardrail positioned along a road.

51. The system of claim 49, wherein the infrastructure element is a telephone pole.

52. The system of claim 49, wherein the infrastructure element is a road and the cable is distributed within the road.

53. The system of claim 44, further comprising:
a signal line comprising an insulated covering configured to permit an electrical signal to pass between the signal line and the antenna; and
a coupling device configured to electrically couple the antenna to the signal line through the insulated covering.

54. The system of claim 53, wherein the electrical signal is a communication signal.

55. The system of claim 53, wherein the electrical signal is a power signal.

56. The system of claim 44, wherein the infrastructure element is a flexible guard post positioned along a road.

57. The system of claim 56, wherein the antenna is integratable with the guard post in a hollow cavity within the guard post.

58. The system of claim 44, wherein the infrastructure element is a reflector configured to be embedded in a road, support the weight of and withstand the impact of a traffic vehicle.

59. The system of claim 58, wherein the antenna is positioned within a cavity in the reflector.

60. The system of claim 59, wherein the antenna is fabricated directly within the reflector.

61. The system of claim 58, wherein the reflector comprises a plug for embedding the reflector in the road.

62. The system of claim 58, wherein a base communication unit is communicatively coupled with the antenna.

63. The system of claim 62, wherein the base communication unit is located remotely from the antenna.

64. The system of claim 62, wherein the base communication unit is communicatively coupled with a plurality of antennas and configured to communicate with a second base communication unit.
